(19) United States
(12) Patent Application Publication
(10) Pub. No.: US 2021/0032107 A1
(43) Pub. Date: Feb. 4, 2021

(54) Methods for the Synthesis of Single-Wall Nanotubes for Energetic Applications

(71) Applicant: Atom Nanoelectronics, Inc., Los Angeles, CA (US)

(72) Inventors: Sean R. Walsh, Los Angeles, CA (US); Christopher L. Harris, Los Angeles, CA (US)

(73) Assignee: Atom Nanoelectronics, Inc., Los Angeles, CA (US)

(21) Appl. No.: 16/799,622

(22) Filed: Feb. 24, 2020

Related U.S. Application Data
(63) Continuation of application No. 15/828,221, filed on Nov. 30, 2017, now abandoned.
(60) Provisional application No. 62/428,388, filed on Nov. 30, 2016.

(51) Int. Cl. C01B 32/162; B82Y 30/00; B82Y 40/00

(52) U.S. Cl. CPC C01B 32/162; C01B 2202/02; B82Y 40/00; B82Y 30/00

(57) ABSTRACT

Single-walled nanotubes for use as additives in energetic materials, and methods for synthesizing such materials are described. The single-walled carbon nanotube (SWNT) additives comprise a mixture of high-purity SWNT and carbon encapsulated iron nanoparticles. The SWNT mixtures may comprise no more than 5% non-SWNT carbon, and the iron nanoparticles may be from 2-5 nm. The method of synthesizing the SWNTs may comprise a high-pressure carbon monoxide (HiPCO) process. The SWNT mixtures may be adapted for use as additives in energetic processes, such as, for example, rocket motors.

### CROSS-REFERENCE TO RELATED APPLICATION

The current application is a continuation of U.S. patent application Ser. No. 15/828,221, filed Nov. 30, 2017 that in turn claims priority to U.S. Provisional Patent Application No. 62/428,388, filed Nov. 30, 2016, the disclosures of which are incorporated herein by reference.

### FIELD OF THE INVENTION

Single-wall nanotube containing compositions for use in energetic applications, and methods of their manufacture are described.

### BACKGROUND OF THE INVENTION

Carbon nanotubes (CNTs) are allotropes of carbon with a cylindrical nanostructure. Their name is derived from their long, hollow structure with the walls formed by one-atom-thick sheets of carbon, called graphene. These sheets are rolled at specific and discrete (“chiral”) angles, and the combination of the rolling angle and radius decides the nanotube properties; for example, whether the individual nanotube shell is a metal or semiconductor. Nanotubes are categorized as single-walled nanotubes (SWNTs) and multi-walled nanotubes (MWNTs). Individual nanotubes naturally align themselves into “ropes” held together by van der Waals forces, more specifically, pi-stacking These cylindrical carbon molecules have unusual properties, which are valuable for nanotechnology, electronics, optics and other fields of materials science and technology. Owing to their extraordinary thermal conductivity, mechanical, and electrical properties, carbon nanotubes find applications as additives to various structural materials.

### BRIEF SUMMARY OF THE INVENTION

The application is directed to single-wall nanotube containing compositions for use in energetic applications, and methods of their manufacture.

Many embodiments are directed to combustion catalysts containing a mixture of high-purity single-walled carbon nanotubes and non-oxidizable metallic nanoparticles.

In some embodiments, no more than 5% of the carbon is non-single-walled carbon nanotubes.

In other embodiments the metallic nanoparticles are from 2 to 5 nm in dimension.

In still other embodiments the metallic nanoparticles are carbon encapsulated iron. In some such embodiments the metallic nanoparticles are encapsulated in a carbon fullerene material.

In yet other embodiments the metallic nanoparticle comprise no greater than 20% of the mass of the mixture.

In still yet other embodiments the single-walled carbon nanotubes comprise at least 95% of the mass of carbon, wherein the metallic nanoparticles are carbon encapsulated iron comprising no greater than 20% of the mass of the mixture.

Many other embodiments are directed to rocket motor opacifiers containing a mixture of high-purity single-walled carbon nanotubes and non-oxidizable metallic nanoparticles.

In some embodiments, no more than 5% of the carbon is non-single-walled carbon nanotubes.

In other embodiments the metallic nanoparticles are from 2 to 5 nm in dimension.

In still other embodiments the metallic nanoparticles are carbon encapsulated iron. In some such embodiments the metallic nanoparticles are encapsulated in a carbon fullerene material.

In yet other embodiments the metallic nanoparticle comprise no greater than 20% of the mass of the mixture.

In still yet other embodiments the single-walled carbon nanotubes comprise at least 95% of the mass of carbon, wherein the metallic nanoparticles are carbon encapsulated iron comprising no greater than 20% of the mass of the mixture.

Still many other embodiments are directed to methods of synthesizing a combustion catalyst including:
introducing a source of carbon and an organometallic catalyst into a reactor at high pressure;
heating the reactor to a reaction temperature such that the organmetallic catalyst decomposes to form metallic nanoparticles; and
reacting the source of carbon with the metallic nanoparticles such that the carbon nucleates on the metallic nanoparticles to form a mixture of high-purity single-walled carbon nanotubes and non-oxidizable metallic nanoparticles.

In some embodiments the source of carbon is selected from the group of benzene, acetylene, CO, and a mixture of CO and hydrogen.

In other embodiments the organometallic catalyst is an iron-containing molecule. In some such embodiments the iron-containing molecule is ferrocene.

In still other embodiments the pressure in the reactor during reaction is from 30-100 atm, and the temperature is at least 1050° C.

In yet other embodiments the single-walled carbon nanotubes comprise at least 95% of the mass of carbon in the mixture, and wherein the metallic nanoparticles are carbon encapsulated iron comprising no greater than 20% of the mass of the mixture.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 provides a flow chart of a method of forming single-walled nanotubes in accordance with embodiments.

FIG. 2 provides pressurization data from ground testing results in accordance with embodiments.

FIG. 3 provides pressurization data from ground testing results in accordance with embodiments.

FIG. 4 provides thrust data from ground testing results in accordance with embodiments.

FIG. 5 provides velocity data from flight testing results in accordance with embodiments.

FIG. 6 provides acceleration data from flight testing results in accordance with embodiments.

### DETAILED DESCRIPTION OF THE INVENTION

Turning now to the drawings, single-walled nanotubes for use as additives in energetic materials, and methods for synthesizing such materials are described. In many embodiments, the single-walled carbon nanotube (SWNT) additives comprise a mixture of high-purity SWNT and carbon encapsulated iron nanoparticles. In various such embodiments the SWNT mixtures comprises no more than 5% non-SWNT carbon. In some such embodiments, the iron nanoparticles are from 2-5 nm. In many embodiments, the method of synthesizing the SWNTs comprises a high-pressure carbon monoxide (HiPCO) process. Various embodiments are also directed to the use of SWNT mixtures for use as additives in energetic processes, such as, for example, rocket motors.

The addition of nano-sized components to energetic materials has been investigated for nearly two decades, with studies showing a direct correlation between decreased particle size and increased burn rate. Explaining this effect is straightforward—smaller particles will, for a given mass of material, have a higher surface area and therefore more reactive sites. While this effect can be substantial, stabilizing the nanoparticles against unwanted oxidation is often a challenge. (See, e.g., Armstrong, R. W., et. al., Nano Lett. 2003, Vol. 3, No. 2, 253-255; Dreizin, E. L., Progress in Energy and Combustion Science 35 (2009) 141-167; Meda, L., et. al., Compos. Sci. Tech. 65 (2005) 769-773; Meda, L., et. al., Mater. Sci. Eng. C 27 (2007) 1393-1396; Pivkina, A., et. al., Propellants, Explosives, Pyrotechnics 29 (2004), No. 1, 39-48; Brousseau, P., Anderson, C. J., Propellants, Explosives, Pyrotechnics 27, 300-306 (2002); Isert, S., Groven, L. J., Lucht, R. P., and Son, S. F.; Combustion and Flame 162 (2015) 1821-1828; Dlott, D. D., Materials Science and Technology, 2006, vol 22 issue 4, 463-473; Rossi, C., Propellants Explos. Pyrotech. 2014, 39, 323-327, the disclosures of which are incorporated herein by reference.)

According to embodiments, SWNTs synthesized according to specific methods may be used as effective additives to energetic materials. In such embodiments, marked improvement in impulse, acceleration and burn rate is seen even at extremely low SWNT loadings by mass. More specifically, it has been discovered that high-purity SWNT carbon containing carbon coated metallic nanoparticles may be used to catalyze combustion, such as, for example, in a rocket motor. Although not to be bound by theory, it is believed that the increased thermal conductivity of SWNTs allows the motor to heat up and burn at a more rapid pace. (See, e.g., Hone, J., et. al., Appl. Phys. A 74, 339-343 (2002); and Sun, K. Stroscio, M. A., Dutta, M., J. Appl. Phys. 105, 074316 (2009), the disclosures of which are incorporated herein by reference.) Additionally, slightly oxidized carbon nanomaterials have been shown to catalyze the combustion of nitrogenated carbon, a common monopropellant. (See, e.g., Chaban, V. V, Fileti, E. E., Prezhdo, O. V., J. Phys. Chem. Lett. 2015, 6, 913-917; Sabourin, J. L., et. al. ACS Nano, 2009, vol 3 issue 12, 3945-3954; and Zhang, C.; Wen, Y.; Xue, X., ACS Appl. Mater. Interfaces 2014, 6, 12235-12244, the disclosures of which are incorporated herein by reference.)

### Methods of Forming SWNTs

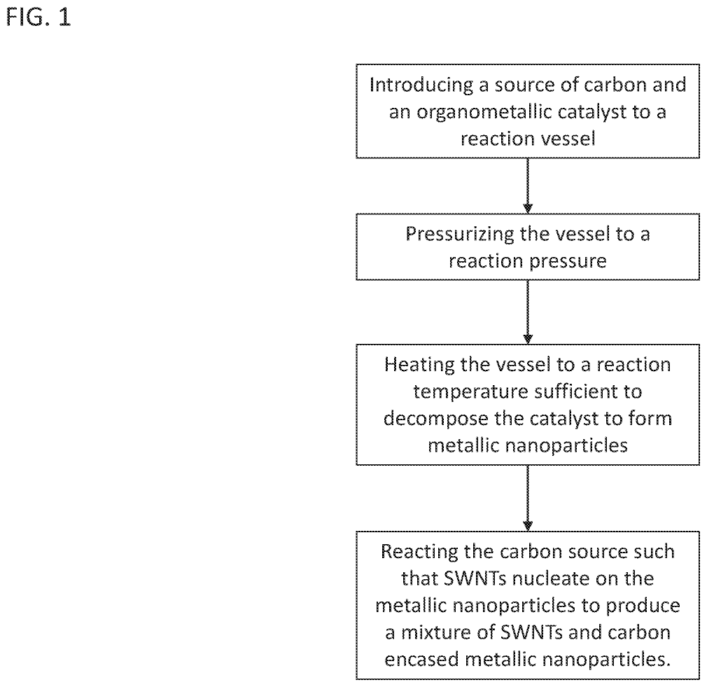

As shown in FIG. 1, various embodiments are directed to methods of forming additives for use in energetic applications. In some such embodiments, the process involves the use of a HiPCO synthesis process. As shown in the flow-chart, the process uses a source of carbon under high pressure in a reactor in conjunction with a catalyst. Catalysts in such processes are formed from a volatile organometallic catalyst precursor introduced into a reactor vessel in the gas phase. These organometallic species decompose under high temperatures to form metallic nanoparticles on which the SWNTs nucleate and grow. In exemplary processes high pressure may include pressures from 30-100 atm, high temperature may include temperatures of 1050° C. or higher. Different metals may be used in accordance with embodiments, including, for example, Fe, which may be present in the form of an organmetallic such as, for example, ferrocene. The carbon source may be any suitable carbon source, including, for example, benzene, C₂H₂, CO and/or CO/H₂ mixtures, and acetylene, among others.

The HiPCO synthesis, in accordance with embodiments, produces high-purity SWNT materials with very low amounts of non-SWNT carbon in the end product (typically less than 5%). The product also includes metallic nanoparticles (e.g., 2-5 nm). In many embodiments these nanoparticles are encased in carbon such that 20% of the mass of the nanoparticle is metal (e.g., iron). These iron nanoparticles are the seeds from which the SWNTs grow and are protected from further oxidation or reaction by the encapsulating carbon, which may be present in the form of carbon buckball, which forms during the synthesis process. Accordingly, in many embodiments the synthesis according to embodiments produces a mixture of SWNT's in high purity (e.g., ˜95% or higher) interspersed with carbon encases nanoparticles (e.g., Fe nanoparticles).

### Energetic SWNT Additives

Many embodiments are directed to combustion catalysis additives comprising mixtures of SWNT carbon and metal nanoparticles. In many embodiments, the additives comprise a mixture of high-purity SWNT carbon (e.g., at least 95% pure) and metallic carbon encapsulated nanoparticles (e.g., iron nanoparticles having a size of 2-5 nm). In many such embodiments up to 20% of the mixture by mass can be iron. In some such embodiments the nanoparticles are encapsulated in a carbon material, such as, for example, spherical carbon (e.g., buckyballs) to prevent further reaction or oxidation of the metallic nanoparticle prior to use.

Accordingly in many embodiments the combustion catalyst material may comprise the following mixture:
Single-walled carbon nanotubes comprising 95% of the total mass of carbon in the mixture;
Metallic nanoparticles (e.g., iron) encapsulated in a carbon material (e.g., fullerenes); and
Wherein the total mass of iron in mixture is no greater than 20%.

In some such embodiments, the SWNT-catalyzed additives may be added to a rocket motor to improve combustion. In such embodiments, it will be understood that any energetic material may be used, however, the opacifier (carbon black) is replaced by the combustion catalysis materials described herein.

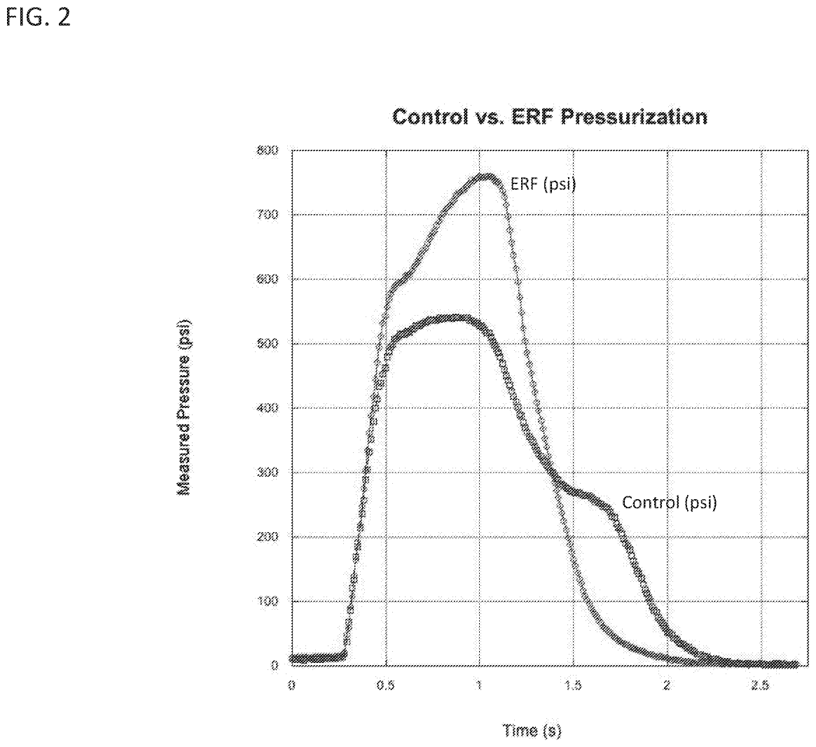

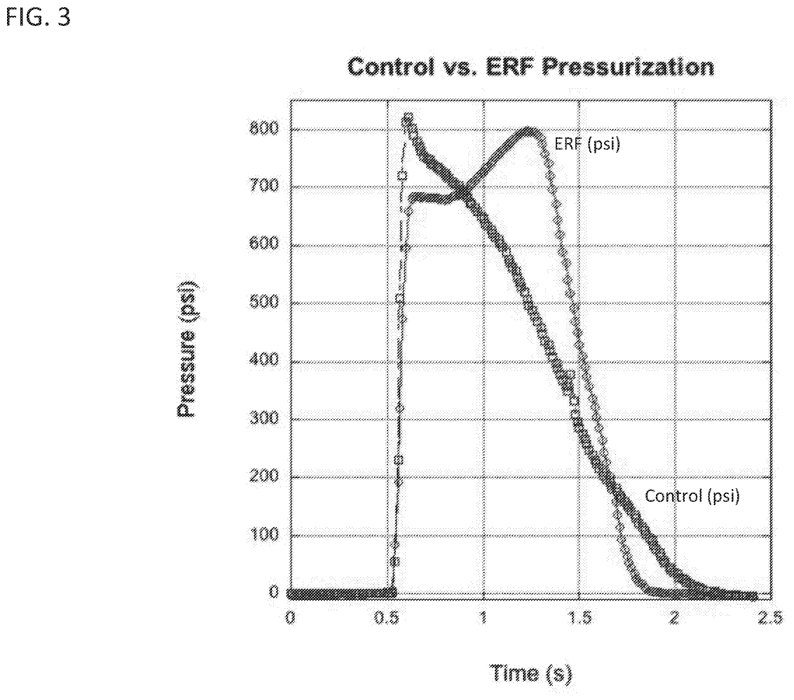

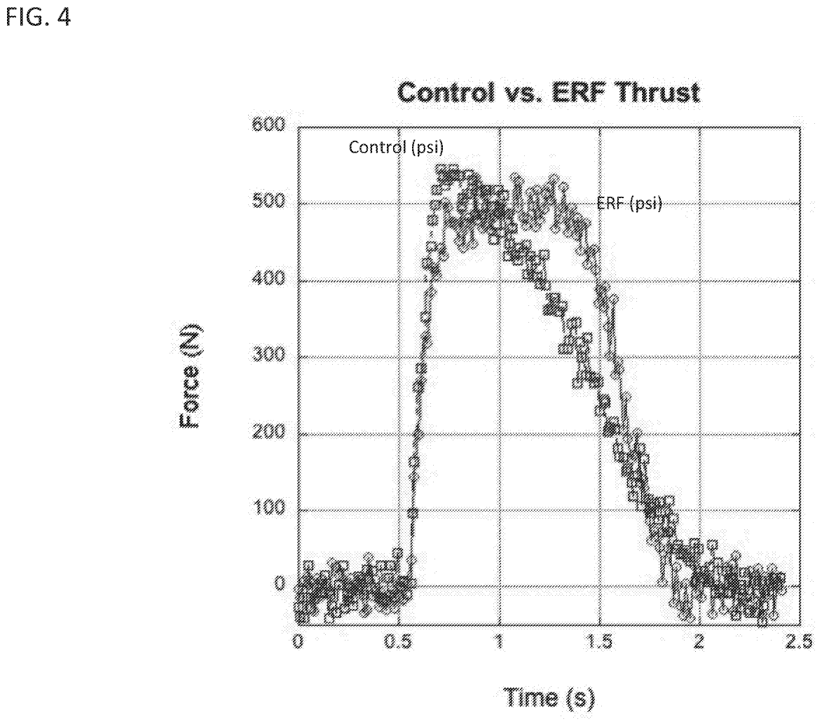

Results of experiments conducted on rocket motors incorporating combustion catalysis SWNT materials in accordance with embodiments are provided in FIGS. 2-6. During the tests multiple solid rocket motors were formed based on hydroxy-terminated polybutadiene (HTPB) cured using an isocyanate hardener. These mixtures were placed in 38 mm BATES molds (circular bore) and allowed to cure, then cut into individual grains. In the tests, the motor recipes of the initial control and experimental motors were identical except for the replacement of the opacifier (carbon black) in the controls with HiPCO SWNTs made according to embodiments. In addition, to ensure controlled compustion metallic nanoparticles in the form of iron powder was added to the controls to account for the presence of iron catalyst in the SWNTs. Three ERF motors were tested; the amount of SWNTs used in the third experimental motor was double that used in the first two motors.

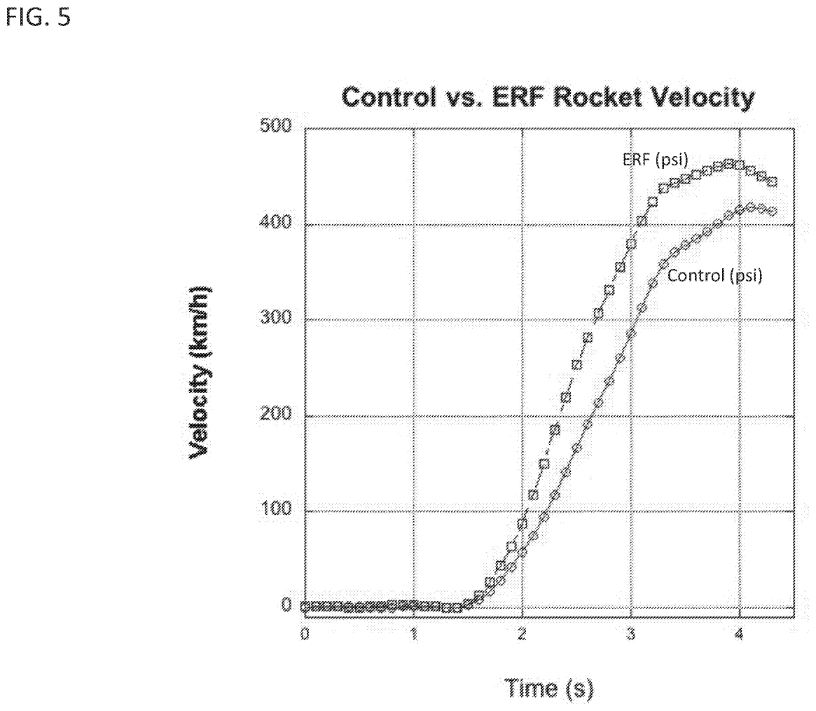

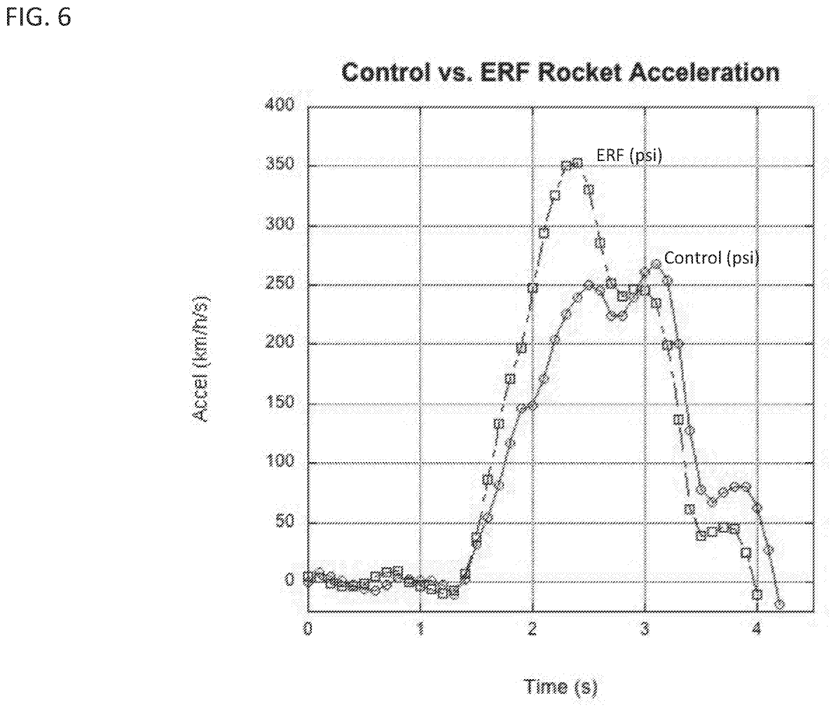

As shown in FIGS. 2-4, the control motors had a regressive thrust profile and standard (i.e. also regressive) pressure profile. The ERF motors ground tested had unusual, progressive pressure profiles, with the peak pressure reached near the end of the burn. This progressive burn also resulted in a neutral thrust profile. Comparing the total impulse of the two motors with thrust data, there was a 4.5% increase in impulse for the ERF over the control. FIGS. 5 and 6 show similarly impressive results. The ERF in this test had double the SWNT added, and the peak velocity achieved by the ERF rocket was 10.7% greater than that of the control. Additionally, the ERF rocket had a peak acceleration 31.7% higher than the control rocket. The smoke trails were also observed and showed that the control rocket had a noticeable smoke trail whereas the ERF rocket's is barely visible.

In summary, it has been surprisingly discovered that SWNT/metal nanoparticle compositions in accordance with embodiments may be used to improve combustion in energetic material applications. Although not to be bound by theory, the combination of small iron nanoparticles, high thermal conductivity and carbon nanomaterial-catalyzed combustion are observed to increase burn rates and total impulse seen in the tests performed. While the latter two components may be found in other carbon nanomaterials, only those produced in accordance with embodiments will contain the carbon encased iron nanoparticles, which are surprisingly found to improve combustion and are also stabilized against oxidation or other reactions.

Although specific combustion catalysis materials, their application and methods of their manufacture, have been provided, it should be understood that other materials and methods may also incorporate the improved combustion catalysis characteristics according to embodiments.

### Doctrine of Equivalents

As can be inferred from the above discussion, the above-mentioned concepts can be implemented in a variety of different implementations in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What is claimed is:

1. A solid rocket motor fuel comprising an energetic material and an opacifier, wherein the opacifier comprises a mixture of high-purity single-walled carbon nanotubes and non-oxidizable metallic nanoparticles.

2. The solid rocket motor fuel of claim 1, wherein no more than 5% of the carbon of the opacifier is non-single walled carbon nanotubes.

3. The solid rocket motor fuel of claim 1, wherein the metallic nanoparticles are from 2 to 5 nm in dimension.

4. The solid rocket motor fuel of claim 1, wherein the metallic nanoparticles are carbon encapsulated iron.

5. The solid rocket motor fuel of claim 4, wherein the metallic nanoparticles are encapsulated in a carbon fullerene material.

6. The solid rocket motor fuel of claim 1, wherein the metallic nanoparticles comprise no greater than 20% of the mass of the mixture.

7. The solid rocket motor fuel of claim 1, wherein the single-walled carbon nanotubes comprise at least 95% of the mass of carbon, wherein the metallic nanoparticles are carbon encapsulated iron comprising no greater than 20% of the mass of the mixture.

8. The solid rocket motor fuel of claim 1 increases the solid rocket motor impulse by about 4.5%.

9. The solid rocket motor fuel of claim 1 increases the solid rocket motor peak velocity by about 10.7%.

10. The solid rocket motor fuel of claim 1 increases the solid rocket motor peak acceleration by about 31.7%.
